(19) United States
(12) Patent Application Publication
(10) Pub. No.: US 2007/0124391 A1
(43) Pub. Date: May 31, 2007

(54) Electronic mail system for a work machine

(75) Inventors: Alan L. Ferguson, Peoria, IL (US); Anthony D. McNealy, Peoria, IL (US); Aaron M. Donnelli, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/289,524

(22) Filed: Nov. 30, 2005

(51) Int. Cl. G06F 15/16

(52) U.S. Cl. 709/206

(57) ABSTRACT

An electronic mail system for a work machine is disclosed. The system includes a controller configured to affect at least one operation of the work machine. The system also includes at least one communicator operatively connected with the controller and configured to communicate at least one signal with the controller. The system further includes a server configured to communicate electronic mail between the controller and a user.

### TECHNICAL FIELD

The present disclosure relates to an electronic mail system and, more particularly, to an electronic mail system for a work machine.

### BACKGROUND

Work machines such as, for example, tractors, marine vessels, generator sets, engines, and/or other types of machinery typically include one or more components, such as for example, work implements, traction devices, propellers, and/or shafts, to perform one or more operations. Work machines often include a controller configured to control the operation of the components to perform a variety of tasks, such as, for example, digging, hauling, moving, and/or power generation. Often the controller receives inputs indicative of a desired operation from an operator and outputs commands to affect the desired operation as a function of the inputs. Typically, the controller interacts with one or more communicators, such as, for example, sensors or actuators, to affect a desired operation and to provide feedback to the operator regarding operating parameters of the work machine. Operators usually communicate with the work machine via a transmission of one or more signals, e.g., a voltage or current level, indicative of, for example, a position of a joystick or a value of an operating parameter.

U.S. Pat. No. 6,760,757 (“the U.S. Pat. No. '757 patent”) issued to Lundberg et al. discloses techniques for using a web based server in a vehicle. Specifically, the system of the U.S. Pat. No. '757 patent discloses an aircraft including a plurality of user terminals configured to communicate with a proxy server. The proxy server is configured to communicate with a satellite via a wireless link during a flight and configured to be connected via a wired link with a ground-based server when the aircraft is stationary on the ground, between flights. During a flight, users may access Internet pages and produce and send electronic mail (hereinafter “e-mail”) via a respective user terminal. The e-mail is temporarily stored within the proxy server and downloaded to the ground-based server when the aircraft lands. The ground-based server subsequently downloads the e-mail via a conventional link for onward transmission. A user may selectively identify and send e-mail via the wireless link via the satellite.

Although the system of the U.S. Pat. No. '757 patent may disclose an aircraft having an e-mail server, users may not be able to request and receive e-mail indicative of an operation of the aircraft. Additionally, the system of the U.S. Pat. No. '757 patent may not control an operation of the aircraft as a function of commands sent via e-mail from users. Furthermore, the aircraft of the U.S. Pat. No. '757 patent may not automatically communicate with users via e-mail.

The present disclosure is directed to overcoming one or more of the shortcomings set forth above.

### SUMMARY OF THE INVENTION

In one aspect, the present disclosure is directed to an e-mail system for a work machine. The system includes a controller configured to affect at least one operation of the work machine. The system also includes at least one communicator operatively connected with the controller and configured to communicate at least one signal with the controller. The system further includes a server configured to communicate e-mail between the controller and a user.

In another aspect, the present disclosure is directed to a method of operating a work machine having at least one component and at least one controller. The method includes sending at least one electronic mail between a user and the least one controller. The method also includes communicating an operational condition of the at least one component with the at least one controller. The method further includes communicating the operational condition of the at least one component with at least one user via electronic mail.

In yet another aspect, the present disclosure is directed to a work machine. The work machine includes at least one component configured to be operated to affect a performance of at least one task. The work machine further includes an electronic mail system including at least one controller and at least one server configured to communicate electronic mail with a user. The electronic mail contains information indicative of an operation of the at least one component.

### BRIEF DESCRIPTION OF THE DRAWINGS

FIG. 1 is a diagrammatic illustration of an exemplary work machine in accordance with the present disclosure; and

FIG. 2 is a diagrammatic illustration of an exemplary e-mail system of the work machine of FIG. 1.

### DETAILED DESCRIPTION

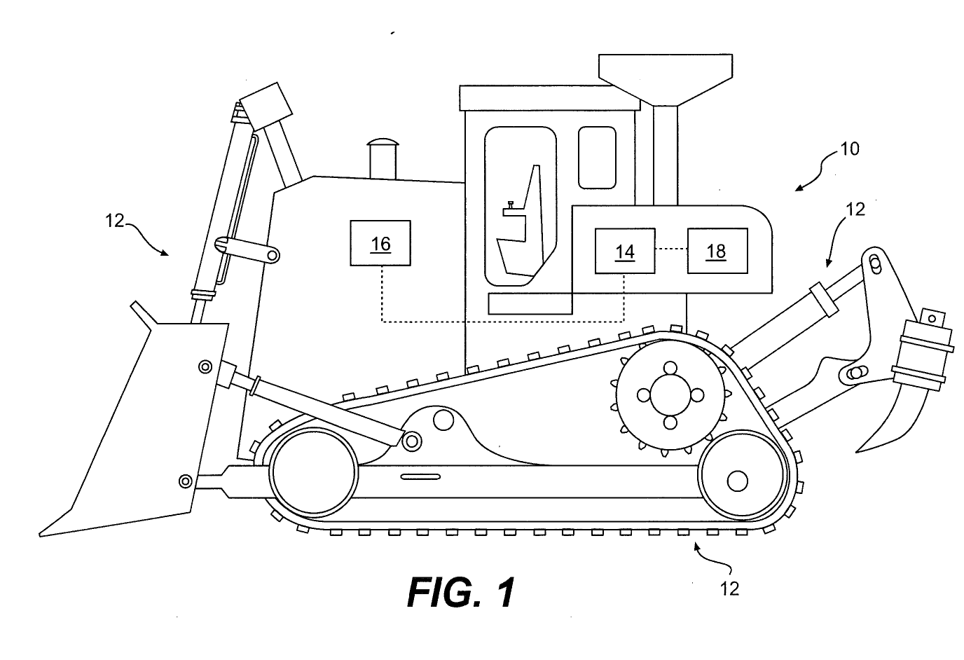

FIG. 1 illustrates an exemplary work machine 10. Work machine 10 may be a fixed or mobile machine that performs some type of operation associated with an industry, such as, for example, mining, construction, farming, and/or any other industry known in the art. For example, work machine 10 may include a tractor, a marine vessel, a generator set, an engine, and/or any other machinery known in the art. For exemplary purposes only, work machine 10 has been illustrated as a tractor, however, it is noted that the disclosure herein is applicable to any work machine. Work machine 10 may include components 12, a controller 14, communicators 16, and a server 18. Controller 14 may be configured to affect control of components 12 as a function of inputs received from communicators 16 and/or via server 18.

Components 12 may be configured to perform or affect performance of one or more operations of work machine 10. Specifically, components 12 may include movable and/or fixed components, may interact with an environment external to work machine 10, and/or interact with other components 12. For example, components 12 of work machine 10 may include movable frame members, hydraulic actuators, traction devices, and/or work implements. One or more of components 12 may work in conjunction with one another to affect movement of a work implement to affect an operation such as, for example, digging. It is contemplated that work machine 10 may include any number and/or any type of component known in the art.

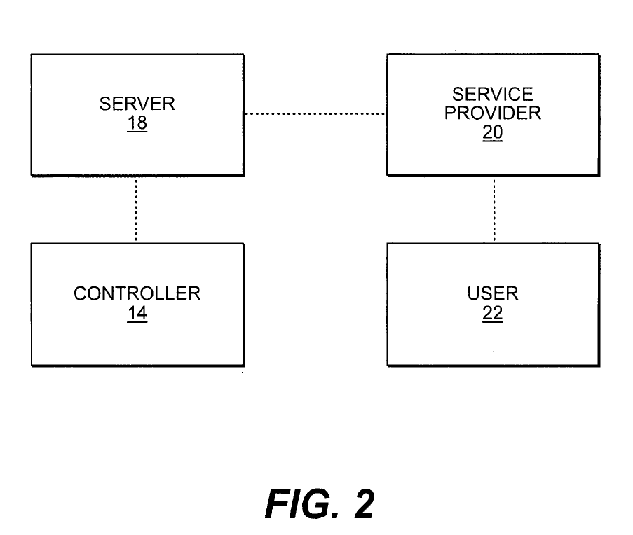

Controller 14 may be configured to affect control of components 12 and thus work machine 10. Controller 14 may include one or more microprocessors, a memory, a data storage device, a communications hub, and/or other components known in the art. Controller 14 may be integrated within a general work machine control system capable of controlling additional various functions of work machine 10. Specifically, controller 14 may be configured to receive inputs communicated from communicators 16 and/or from a user 22 (see FIG. 2) via server 18, e.g. signals or e-mail. Controller 14 may perform one or more algorithms to determine appropriate output signals, and communicate the output signals to one or more of communicators 16 to affect control of components 12. Additionally, controller 14 may be configured to perform one or more algorithms to generate e-mail as a function of signals communicated with communicators 16 and/or inputs received via server 18. The generated e-mail may be created within server 18 and/or generated within controller 14 and delivered to server 18. It is contemplated that controller 14 may be further configured to receive inputs indicative of various operating parameters of work machine 10 and/or components 12 from one or more of communicators 16. It is also contemplated that controller 14 may be configured to control the operation of additional systems of work machine 10, such as, for example, audio or visual displays and/or any other system known in the art. It is further contemplated that controller 14 may be configured to recognize text within e-mail to identify inputs communicated from user 22, by performing appropriate algorithms such as, for example, executing one or more software programs.

Communicators 16 may be configured to communicate signals indicative of an operation of components 12 and/or operating parameters of work machine 10 with controller 14. Specifically, communicators 16 may include active, e.g., a voltage level, and/or passive, e.g., a non-invasive sensor, to monitor and/or affect operation of components 12 and/or work machine 10. For example, communicators 16 may include operator interface devices, temperature and/or position sensors, audio and/or visual alarms, timers, displays, monitors, input/output devices, controllers, global positioning systems, radio frequency transmitters, voltage and/or current transmitters, infrared and/or optical transmitters, solenoids, mechanical, electrical and/or virtual switches, and/or any other known communication device known in the art. Communicators 16 may each be configured to monitor and/or affect operation of one or more of components 12. For example and considering work machine 10 to embody a tractor for exemplary purposes only, one of communicators 16 may be configured to monitor a position of a hydraulic actuator which may, via an extension or retraction thereof, affect movement of a work implement. For another example, one of communicators 16 may be configured to affect movement of a valve operatively associated with a hydraulic system which may, dependant upon a position thereof, direct pressurized fluid to and/or from chambers within a hydraulic actuator affecting movement of a hydraulic actuator. It is contemplated that communicators 16 may include any number of communicators each configured to communicate with controller 14 and operatively associated with one or more of components 12 and/or work machine 10. It is further contemplated that communicators 16 may interact with controller 14 in any suitable manner, such as, for example, via radio frequencies, hardwired connections, optically, and/or any manner known in the art.

FIG. 2 illustrates server 18 with respect to controller 14, a service provider 20, and a user 22. Specifically, server 18 may be configured to communicate with controller 14 and service provider 20 to send and receive e-mail therebetween. Service provider 20 may be configured to send and receive e-mail with server 18 and enable user 22 to generate and access e-mail. It is contemplated that server 18, service provider 20, and user 22 may respectively communicate with one another in any suitable manner, such as, for example, via a wired or wireless connection, via the Internet, via a local area network, and/or any other manner known in the art. It is contemplated that user 22 may include a worker, a controller, a computer, and/or any suitable entity configured to affect an operation of work machine 10.

Server 18 may be configured to send and receive e-mail and may include any suitable server known in the art. Specifically, server 18 may be configured to communicate with controller 14 and service provider 20 to send and receive e-mail with both controller 14 and service provider 20. Server 18 may include software and/or hardware configured to perform one or more algorithms to send and receive e-mail as is conventional in the art. It is contemplated that server 18 may be integrated within controller 14.

Service provider 20 may be configured to send and receive e-mail with server 18 and may include any suitable service provider known in the art. Specifically, service provider 20 may be configured to enable user 22 to create and send e-mail to server 18. Service provider 20 may also be configured to receive e-mail from server 18 and enable user 22 to access and/or view received e-mail. For example, service provider 20 may include software and/or hardware configured to perform one or more algorithms to communicate according to any conventional e-mail protocol as is known in the art. It is contemplated that user 22 may create, send, and/or access e-mail within service provider 20 via a computer including input and output devices, via a cellular phone, and/or via any other suitable manner known in the art. It is also contemplated that service provider 20 and/or user 22 may be disposed at any position with respect to work machine 10. For example, service provider 20 and/or user 22 may be disposed at a local position, e.g., within visual range of work machine 10, and/or a remote location, e.g., a field office or a headquarters, separated from work machine 10 by any distance.

E-mail may include any message including text communicated over an electronic communication system. E-mail may be communicated via Simple Mail Transfer Protocol (“SMTP”), e.g., communicated via the Internet, via non-standard protocols, e.g., communicated within a local area network, and/or via any protocol known in the art. E-mail may include an address header, a subject, and a body as is conventional in the art. The address heading may include a recipient address and a sender address, e.g., “user@serviceprovider.com.” The subject may include text identifying the topic of the e-mail and the body may include any text arranged to communicate one or more ideas. It is contemplated that e-mail may include any type of text including, for example, any type of font, letters, numbers, symbols, language, encoded text, encrypted text, and/or quantity of text within the subject and/or body. It is also contemplated that e-mail may be communicated to and/or from any address and may or may not include text within either a body or a subject. It is further contemplated that e-mail may include one or more attachments such as, for example, text files, executable program files, picture files, and/or any type of file known in the art.

Specifically, e-mail communicated by user 22 may include text configured as one or more commands to controller 14. User 22 may generate and send e-mail to controller 14, via service provider 20 and server 18, including text arranged within a subject, body, and/or attachment which controller 14 may recognize as an input. E-mail sent by user 22 may control controller 14 to perform one or more algorithms and to output appropriate signals to communicators 16 to affect operation of components 12 and thus work machine 10. As such, controller 14 may be controllable as a function of inputs received via e-mail. Additionally, controller 14 may automatically generate e-mail when a value of a parameter of work machine 10 exceeds or falls within a predetermined range of values and/or is greater or less than a predetermined value. As such, user 22 may be notified of the operational condition of work machine 10 as a function of e-mail sent from controller 14. It is contemplated that an e-mail sent from user 22 including an attachment may include inputs recognizable by controller 14 to perform an algorithm included within the attachment, such as, for example, an algorithm to reprogram a portion of controller 14, e.g., a software update.

### INDUSTRIAL APPLICABILITY

The disclosed e-mail system may be applicable to any work machine and may allow e-mail communications between user 22 and work machine 10. The operation of work machine 10 and, in particular, server 18 is explained below with reference to work machine 10 embodied as a tractor for exemplary purposes only and it is noted that the explanation below is applicable to any work machine.

Work machine 10 may be operated as a function of inputs communicated from communicators 16. For example, controller 14 may include one or more algorithms configured to monitor communicators 16 and automatically control components 12 as a function of signals received from communicators 16. Also, components 12 and thus operation of work machine 10 may be controllable by an operator operatively associated with respect to work machine 10 as is conventional in the art. For example, an operator may via actuation of operator interface devices, control components 12, e.g., movement of a joystick.

Additionally, components 12 and thus work machine 10 may be controllable by user 22 via e-mail communicated via service provider 20 and server 18. For example, user 22 may monitor and/or control components 12 to perform one or more operations via server 18. Specifically, controller 14 may receive an e-mail from user 22 including text arranged as one or more inputs. Controller 14 may recognize the inputs and may perform one or more algorithms in response thereto. Controller 14 may send and/or receive signals with communicators 16 as a function of the inputs and the performed algorithms to monitor and/or control components 12. Controller 14 may deliver an e-mail to user 22 via server 18 including text indicative of the performed algorithms, signals sent or received with communicators 16, and/or other information, e.g., any type of data.

User 22 and controller 14 may send and receive e-mail therebetween so as to monitor and/or control the operation of work machine 10. Specifically, user 22 may be interested in the operation of work machine 10 and may desire information indicative of one or more operating parameters of work machine 10. As such, user 22 may generate and send an e-mail via server 18 to controller 14 configured to command controller 14 to perform a particular algorithm, such as, for example, an algorithm configured to receive a signal from one of communicators 16, generate an e-mail, and send the e-mail to user 22 via server 18 to textually represent the received signal. Additionally, user 22 may desire movement of one or more of components 12 to establish a particular operation of work machine 10. As such, user 22 may similarly generate and send an e-mail to controller 14 configured to command controller 14 to perform a particular algorithm, such as, for example, an algorithm configured to communicate an output signal to one or more of communicators 16 to affect movement of one or more of components 12 to establish the particular operation of work machine 10. Furthermore, controller 14 may be configured to perform one or more algorithms configured to automatically generate and send e-mail in response to signals received from communicators 16 exceeding or falling within predetermined ranges and/or being greater or less than a predetermined value.

For example, if user 22 desired information regarding a pressure of pressurized fluid within a hydraulic actuator, user 22 may send an e-mail to controller 14 including inputs therein recognizable by controller 14 as a command to determine the appropriate pressure, e.g., including the text “pressure of hydraulic actuator” within the subject. Accordingly, controller 14 may recognize the text and perform an algorithm to receive a signal from one of communicators 16, e.g., a pressure sensor operatively associated with the hydraulic actuator. Controller 14 may be configured to automatically generate and send an e-mail via server 18 to user 22 including text recognizable by user 22 as the determined pressure, e.g., the text “pressure equals 120 kPa.” Similarly, user 22 may deliver inputs to controller 14 to affect operation of components 12. It is contemplated that user 22 may generate text within predetermined and/or unrestrained arrangements for recognition by controller 14. It is also contemplated that controller 14 may alternatively not generate and send an email indicative of an executed command such as, for example, when user 22 desires an operation of one of components 12.

Because work machine 10 may send an e-mail to user 22 containing information indicative of the operational condition of work machine 10 and/or components 12, user 22 may not require prior knowledge to interpret the e-mail. For example, if work machine 10 communicated a signal, e.g., a voltage or current level, user 22 would require prior knowledge as to what the signal represents and/or indicates. By sending e-mail, user 22 may not require prior knowledge and may interpret the information communicated from work machine 10 by recognizing text. Because work machine 10 communicates with user 22 via a service provider, work machine 10 and user 22 may be untethered and/or located at any distance relative to work machine 10, e.g., work machine 10 and user 22 may send and receive e-mail via a wireless connection and/or the Internet and allow remote monitoring and/or control of one or more operations of work machine 10. Additionally, work machine 10 may be controllable by an operator, e.g., not user 22, operatively associated with work machine 10, e.g., positioned locally with respect to work machine 10, via a conventional manner, e.g., via operator interface devices regardless of e-mail communication between user 22 and controller 14. It is contemplated that priority between a remote input, e.g., from user 22 via e-mail and a local command, e.g., from an operator via an operator interface device, may be resolved on a case by case basis and/or user 22 may, via one or more particular commands, selectively override an input delivered to controller 14 from an operator interface device.

It will be apparent to those skilled in the art that various modifications and variations can be made to the disclosed e-mail system for a work machine. Other embodiments will be apparent to those skilled in the art from consideration of the specification and practice of the disclosed system. It is intended that the specification and examples be considered as exemplary only, with a true scope being indicated by the following claims and their equivalents

What is claimed is:

1. An electronic mail system for a work machine comprising:
a controller configured to affect at least one operation of the work machine;
at least one communicator operatively connected with the controller and configured to communicate at least one signal with the controller; and
a server configured to communicate electronic mail between the controller and a user.

2. The electronic mail system of claim 1, further including a service provider configured to communicate at least one electronic mail between the server and the user.

3. The electronic mail system of claim 1, wherein the controller is further configured to perform at least one algorithm in response to at least one input communicated by the user via an electronic mail sent to the server.

4. The electronic mail system of claim 1, wherein the controller is further configured to send an electronic mail via the server to the user, the electronic mail configured to indicate a value of the at least one signal.

5. The electronic mail system of claim 4, wherein the controller is configured to automatically send the electronic mail when the value of the at least one signal exceeds or falls within a predetermined range of values.

6. The electronic mail system of claim 1, wherein the controller is further configured to affect operation of a component operatively connected to the work machine as a function of an input received from the user, the input communicated to the controller in an electronic mail.

7. The electronic mail system of claim 1, wherein the controller is configured to perform at least one algorithm in response to a first electronic mail received from the user, the algorithm configured to determine a value of at least one parameter of the work machine and send a second electronic mail to the user, the second electronic mail indicating the value of the at least one parameter.

8. The electronic mail system of claim 1, wherein the user is disposed remotely with respect to the work machine.

9. A method of operating a work machine having at least one component and at least one controller, the method comprising:
sending at least one electronic mail between a user and the least one controller;
communicating an operational condition of the at least one component with the at least one controller; and
communicating the operational condition of the at least one component with at least one user via electronic mail.

10. The method of claim 9, wherein sending at least one electronic mail between a user and the at least one controller includes sending an electronic mail from the user to the work machine, the electronic mail configured to affect an operation of at least one component.

11. The method of claim 10, wherein the electronic mail is further configured to command the at least one controller to perform at least one algorithm configured to output at least one signal to a communicator to affect the operation.

12. The method of claim 9, wherein sending at least one electronic mail between a user and the at least one controller includes sending an electronic mail from the user to the work machine, the electronic mail configured to monitor an operation of at least one component.

13. The method of claim 12, wherein the electronic mail is further configured to command the at least one controller to perform at least one algorithm configured to receive at least one signal from a communicator indicative of the operation.

14. The method of claim 9, wherein sending at least one electronic mail between a user and the at least one controller includes the at least one controller automatically sending an electronic mail to the user, the electronic mail configured to indicate a value of at least one signal received by the controller.

15. The method of claim 14, wherein the at least one controller is further configured to:
receive the at least one signal from at least one communicator; and
send the electronic mail when the value of the at least one signal is greater or less than a predetermined value.

16. A work machine comprising:
at least one component configured to be operated to affect a performance of at least one task;
an electronic mail system including at least one controller and at least one server, the electronic mail system configured to communicate electronic mail with a user, the electronic mail containing information indicative of an operation of the at least one component.

17. The work machine of claim 16, wherein the server is configured to send an electronic mail to the user.

18. The work machine of claim 16, wherein the server is configured to receive an electronic mail from the user.

19. The work machine of claim 16, wherein the electronic mail is further configured to affect control of the at least one component.

20. The work machine of claim 16, wherein the electronic mail is further configured to textually represent at least one operational parameter of the work machine.

21. The work machine of claim 16, wherein the controller configured to:
affect the operation of the at least one component;
monitor at least one parameter of the work machine;
perform one or more algorithms to generate a first electronic mail when a value of the at least one parameter exceeds or falls within a predetermined range of values; and
control the server to send the first electronic mail to a user.
